(19) United States
(12) Patent Application Publication
(10) Pub. No.: US 2008/0214215 A1
(43) Pub. Date: Sep. 4, 2008

(54) Systems and methods for facilitating information control of a device by proxy

(76) Inventors: Janne L. Aaltonen, Turku (FI); Janne Antola, Laitila (FI); Mika Kavanti, Naantali (FI)

Correspondence Address: Hollingsworth & Funk, LLC, Suite 125, 8009 34th Avenue South, Minneapolis, MN, 55425, US

(21) Appl. No.: 11/713,247

(22) Filed: Mar. 2, 2007

(51) Int. Cl. H04Q 7/20

(52) U.S. Cl. 455/466

(57) ABSTRACT

Systems, methods and apparatuses for enabling the configuration and/or control of data, content or other information affecting a device(s) by way of another device(s). A first device, such as a mobile device, is associated with a network-addressable document(s). The network-addressable document(s) are provided to a second device, such as a computing device. Recognition of user identification a content item(s) is identified by way of the network-addressable document(s) presented via the second device. A transfer is initiated of the identified content item(s) to the first device that is associated with the at least one network-addressable document.

### RELATED APPLICATIONS

This application is related to U.S. application Ser. No. ______, filed on Mar. 1, 2007, Attorney Docket Number NKM. 155.A1 (NC 53125 US), and entitled “Systems And Methods For Facilitating Authentication Of Network Devices.”

### FIELD OF THE INVENTION

This invention relates in general to the communication of data, and more particularly to systems, methods and apparatuses for enabling the configuration and/or control of data, content or other information affecting a device(s) by way of another device(s).

### BACKGROUND OF THE INVENTION

Advances in communication infrastructures and devices have turned standard communication devices into valuable tools. People communicate with each other, and with other electronic devices, over networks ranging from Local Area Networks (LANs) to wide reaching Global Area Networks (GANs) such as the Internet. Wireless communications devices such as mobile phones, Personal Digital Assistants (PDAs), and the like are often designed to interface with such networks as well as with their local surroundings using short-range wireless technologies.

Both landline and wireless computing systems are presently capable of receiving information in a variety of content types and formats, from a variety of different sources including networked sources. Landline systems, such as desktop computers, workstations, terminals, etc. generally utilize commercially-available Web browsers in order to interact with various kinds of Internet resources. This type of browser is generally a software program stored locally at the client device. In the Internet context, web content created with Hypertext Markup Language (HTML) or other language can be read by such Web browsers. Analogous technologies exist for communicating landline content via wireless devices.

There is an ever-increasing demand for the consumption of Internet or other network-sourced content on smaller devices such as mobile phones, Personal Digital Assistants (PDAs), laptop computers and the like. For example, the popularity and resulting proliferation of these portable and/or hand-held wireless devices has fueled the need to make content traditionally available to desktop and other landline computing systems also available to mobile device users. However, there are various factors that limit a user's ability efficiently utilize Internet content on mobile devices. Such factors include the limited display capabilities and limited or otherwise tedious user input mechanisms due to the relatively small housing size of mobile devices.

More particularly, multimedia capabilities of mobile phones and other small communication devices are making it possible to use rich media content such as videos. For multimedia content such as video clips, user consumption occurs almost entirely via the Internet using personal computers with standard user interface mechanisms. One typical scenario would be, for example, a user using a laptop or fixed computer to access a website whereby the user views, purchases or otherwise consumes an audio, video or other media/multimedia content item from the website for use on the laptop computer. If the user wanted the content to be available in the user's mobile device, the user would typically download the content from the laptop/fixed computer using a wired or wireless proximity connection. Some websites are, however, geared to mobile users where dedicated web pages are configured for consumption on smaller mobile devices. From such a website, a mobile user can retrieve content without an intermediary laptop/fixed computer.

However, due to special requirements of mobile devices and mobile environments, it is difficult to easily initiate content sales and distribution to mobile devices. Current mechanisms do not allow scalable business from the Internet or other network-based systems to the mobile domain. For example, in order for a website owner or content owner to initiate a business in the mobile domain today, a primary problem is the comparatively complex and costly environment for establishing a mobile market place. This obstacle is preventing countless companies from entering this market. This is particularly true of website owners and content developers whose product is somewhat out of the mainstream, e.g., those markets that find a niche consumer or audience and do not cater to or otherwise appeal to the masses. In such niche markets, it is not difficult to see why the complexity and consequent cost would dissuade such niche market providers from distributing content to mobile devices, even moreso than large market content providers which may be better suited to handle the increased complexity and cost.

Another problem with distributing or otherwise providing content to mobile devices is the usage of existing mobile sites. As previously indicated, mobile and other relatively small devices typically have limited user interface (UI) capabilities compared to their desktop counterparts. For example, a mobile phone may not have a full keyboard, but rather enables users to enter alphanumeric information via the numeric keypad. Even devices incorporating full alpha keyboards (e.g., QWERTY keyboard) do not facilitate two-hand typing as with desktop computers, but rather often requires finger and/or thumb text entry which can be difficult for some users. Entry of a uniform resource identifier (URI) such as a uniform resource locator (URL) to seek a website can therefore be awkward, cumbersome and time consuming. Unfortunately for mobile content providers, this serves as a significant disincentive for mobile content consumers.

As indicated above, there are various shortcomings with conventional content distribution methodologies, particularly in the wireless/mobile device arena. To maximize the intended benefit of technological advances in content-consuming capabilities of mobile devices and other computing devices, more suitable content distribution mechanisms and methodologies are required to address the various device characteristics and diverse needs of the content-consuming public.

Accordingly, a need exists to address these and other problems of the prior art. The present invention addresses these and other problems and shortcomings of the prior art, and offers a variety of benefits and advantages over conventional techniques.

### SUMMARY OF THE INVENTION

To overcome limitations in the prior art described above, and to overcome other limitations that will become apparent upon reading and understanding the present specification, the present invention discloses systems, apparatuses and methods for enabling the configuration and/or control of data, content or other information affecting a device(s) by way of another device(s).

In accordance with one embodiment of the invention, a method is provided that involves associating a first device with at least one network-addressable document (e.g., web page). The network-addressable document is provided to a second device. The method involves recognizing user identification of a content item identified by way of the network-addressable document presented via the second device. A transfer of the identified content item is initiated to the first device that is associated with the network-addressable document.

According to other particular embodiments of such a method, a region(s) is provided on the network-addressable document, where recognizing user identification of a content item involves recognizing user correlation of the content item with the region(s) on the addressable document. In another particular embodiment, at least one region is presented via the addressable document, and user correlation of the content item with the region is facilitated. In another particular embodiment, recognizing user identification of the content item involves recognizing moving an icon identifying the content item to the region via a drag-and-drop graphical user interface. In another embodiment, a visual representation of the first device is presented at the presented region of the addressable document. In yet another embodiment, at least some of the information between the first device and the visual representation of the first device is synchronized. In another embodiment, a state of the first device is incorporated with the visual representation of the first device.

In other particular embodiments of such a method, associating a first device with a network-addressable document involves modifying the network-addressable document code to include a code segment that associates the first device with the network-addressable document. In one embodiment, the code segment is implemented using a Hypertext Markup Language (HTML) Application Programming Interface (API).

One embodiment of such a method involves associating the first device with a network-addressable document by providing a site-specific identifier and code segment to a network service providing the network-addressable document, where the site-specific identifier associates the network-addressable document with the first device, and the code segment enables a browser application on the second device to present information regarding the first device via the network-addressable document. In another embodiment, the code segment enables the browser application on the second device to present a representation of the first device via the network-addressable document. Yet another embodiment involves the code segment enabling the browser application on the second device to present the state of the first device via the network-addressable document.

In one embodiment, the method involves facilitating selection, via the second device, of one or more content items presented on the network-addressable document(s) for use by the first device. Other embodiments involve various manners of recognizing user identification of the content item(s), such as recognizing a user voice command of the content item(s), recognizing user entry of text that identifies the content item(s), recognizing user selection of the content item(s) via a graphical user interface, etc.

In other embodiments the method involves registering the first device with the network-addressable document, and incorporating code corresponding to the registered first device. In another embodiment initiating a transfer of the identified content item to the first device involves transferring the identified content item(s) from a server hosting the network-addressable document to the first device. One embodiment involves initiating the transfer of the identified content item(s) to the first device by initiating the transfer via a network service hosting the network-addressable document. Another embodiment further involves the network service transferring the content item to an intermediary server operating as personal storage for the first device, and providing the content item to the first device by synchronizing the personal storage at the intermediary server with the first device. In still another embodiment, transferring the content item to an intermediary server operating as personal storage for the first device involves transferring the content item to a database at the intermediary server serving as a personal video recorder (PVR).

In accordance with another embodiment, a method is provided that includes generating a device association key that associates a web page with a communication device, providing the device association key to a requesting network service hosting the web page, providing a representation of a communication device to the web page that is identified by the device association key, and identifying content selected using the representation of the communication device on the web page presented via the computing device, and facilitating a transfer of the selected content to the communication device.

In one particular embodiment, such a method involves providing a supplementary code segment for inclusion into the web page as an Application Programming Interface (API). In another embodiment, facilitating a transfer of the selected content to the communication device involves synchronizing data with the communication device. In another embodiment, facilitating a transfer of the selected content to the communication device involves notifying the network service hosting the web page to transmit the content to the communication device. Yet another embodiment involves facilitating a transfer of the selected content to the communication device by receiving the content from the network service hosting the web page, and synchronizing the content with the communication device.

In accordance with another embodiment of the invention, an apparatus is provided that includes at least a transmitter, a receiver, and a processor. The receiver is configured to receive a request from a network service hosting a web page for a device association key that associates a web page with a communication device. The processor is configured to generate the device association key, and to direct the transmitter to provide the device association key to the network service for inclusion into the web page. The processor is further configured to provide a representation of the communication device to the web page being accessed by a computing device, and to facilitate a transfer to the communication device of content identified by graphically moving a content identifier to the representation of the communication device.

According to more particular embodiments of such an apparatus, the processor is further configured to facilitate registration of the user's mobile phone and consequent association with the website. Another embodiment involves the processor being further configured to recognize which one or more content identifiers have been dragged or otherwise associated with the representation of the communication device.

In accordance with another embodiment of the invention, a method is provided that includes registering a first device with a device association service and a network service, authenticating the first device with the device association service, and if authenticated, the device association service associating the first device with at least one network-addressable document hosted by the network service. The method further includes providing the network-addressable document to a second device, recognizing user identification of a content item(s) identified by way of the at least one network-addressable document presented via the second device, and authenticating the first device with the network service. If authenticated, the processor initiates a transfer of the identified content item(s) to the first device.

More particular embodiments of such a method include authenticating the first device with the network service by utilizing an identifier already affiliated with the first device as a username, generating a password and an authentication key based on at least the username, and upon attempted access to the network service by the first device, exchanging the username, password and authentication key to determine the authenticity of the first device. Another embodiment involves utilizing an identifier already affiliated with the first device as a username; generating a password and an authentication key based on at least the username, and upon attempted access to the device association service by the first device, exchanging the username, password and authentication key to determine the authenticity of the first device.

In accordance with another embodiment of the invention, a method is provided that involves associating the first device with a network-addressable document(s) hosted by the network service, facilitating a sign-on procedure to enable the first device to sign on to the network service, providing the network-addressable document to a second device, recognizing user identification of at least one content item identified by way of the at least one network-addressable document presented via the second device, and if the sign-on procedure is successful, initiating a transfer of the at least one identified content item to the first device.

A more particular embodiment of such a method addresses the facilitating of a sign-on procedure to enable the first device to sign on to the network service, and involves receiving a notification of a user requesting access to the network service, generating an identification key for a session of the network service that provides the network-addressable document, and providing the identification key to the network service session for presentation to the user requesting access to the network service, receiving a user-entered identification key via the network service session, and comparing the generated identification key to the user-entered identification key to effect the sign-on procedure. Yet another embodiment involves signing the user onto the network service session if the generated identification key corresponds to the user-entered identification key.

In accordance with another embodiment of the invention, an apparatus is provided that includes a processor configured to register the apparatus to a device association system. A receiver is configured to receive media identified via operations taken relative to an external representation of the registered apparatus. A user interface is configured to present the externally identified media. According to a more particular embodiment of such an apparatus, the receiver is configured to receive the media by way of a synchronization event with storage associated with the device association system. According to another particular embodiment of such an apparatus, the receiver is configured to receive the media directly from a content server.

The above summary of the invention is not intended to describe every embodiment or implementation of the present invention. Rather, attention is directed to the following figures and description which sets forth representative embodiments of the invention.

### BRIEF DESCRIPTION OF THE DRAWINGS

The invention is described in connection with the embodiments illustrated in the following diagrams.

FIG. 1 illustrates an example of a manner of providing content to a content-consuming computing and/or communication device in accordance with the present invention;

FIG. 2 is a flow diagram illustrating one exemplary manner in which content can be identified for delivery to a targeted device;

FIG. 3 is a flow diagram illustrating another embodiment of a method for providing content to a content-consuming device;

FIG. 4 illustrates some representative delivery mechanisms that may be used in connection with the present invention;

FIG. 5 illustrates a representative flow diagram and code segment that can be used to generate a web page(s) that include a device association functionality in accordance with the invention;

FIG. 6 is a flow diagram illustrating one embodiment of a manner of using the web pages/documents that incorporate the device-associated user interface for identifying deliverable content in accordance with the present invention;

FIG. 7A illustrates an exemplary web page that can be presented via the user's accessing system;

FIG. 7B illustrates a message flow diagram representing a user's involvement with the web page and ultimate ability to obtain media on another device;

FIG. 8 illustrates one embodiment of a manner for authenticating a device with a network service;

FIG. 9 is a message flow diagram illustrating one embodiment whereby a device may be authenticated with a network service in accordance with the present invention;

FIG. 10 is a flow diagram illustrating an exemplary manner of logging on to a network or other service without requiring a username/password pair to be entered by the user;

FIG. 11 is a flow diagram illustrating another embodiment of a manner of logging on to a network or other service without requiring a username/password pair to be entered by the user;

FIG. 12 illustrates an exemplary manner of presenting a signing code;

FIGS. 13 and 14 are flow diagrams of exemplary embodiments of manners of opening multiple service sessions with a reduced number of logins; and

FIG. 15 illustrates a representative system(s) in which the present invention may be implemented or otherwise utilized.

### DETAILED DESCRIPTION OF THE ILLUSTRATED EMBODIMENTS

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

In the following description of the exemplary embodiment, reference is made to the accompanying drawings which form a part hereof, and in which is shown by way of illustration various manners in which the invention may be practiced. It is to be understood that other embodiments may be utilized, as structural and operational changes may be made without departing from the scope of the present invention.

Generally, the present invention enables servers or other network elements that host information/websites to provide a device-associated user interface region(s) via the website, where a user interface (UI) action(s) taken relative to the device-associated user interface region(s) of the website triggers a corresponding activity(s) on the actual device that is associated with that user interface region(s). Embodiments of the invention also involve a representative manifestation of the device (e.g., a “virtual device”) to be presented at the device-associated user interface region(s), to provide the user with a visual representation of the action(s( that will actually occur on the user's corresponding, actual device. Forms of “presenting” the virtual device in addition or in lieu of presenting a visual image of the device can be used, such as audio, video, animation, etc.

For example, one embodiment of the invention enables a new website to include, or an existing website to be modified to include, a module that enables that website to present via a one computing system (e.g., computing system-A) some indicia representing another computing system (e.g., computing system-B) capable of utilizing the content otherwise made available to computing system-A. For instance, the computing system-A may be a user's desktop or laptop computer, which by way of a browser application presents a web page(s) hosted by a content server. In one representative embodiment, the web page(s) can include a module in accordance with the present invention that enables that web page(s) to present a location or frame on the web page(s) that serves as a “drop area” in a drag-and-drop graphical user interface (GUI) environment. This frame corresponds to another device (ie., computing system-B), such as a mobile phone, PDA, laptop, or other system capable of receiving content. The module enables the user to drag-and-drop items representing content to the drop area via the browser of the computing system-A, where the drop area designates the content that is to be physically transferred to the user's other device, i.e., computing system-B.

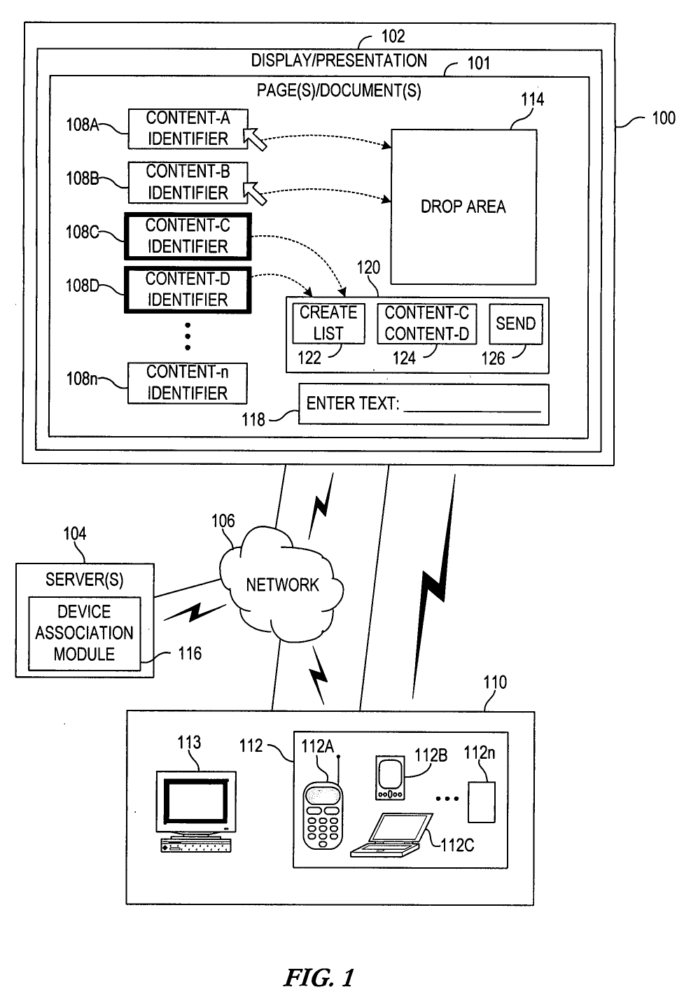

FIG. 1 illustrates one particular example of a manner of providing content to a content-consuming computing and/or communication device in accordance with the present invention. The term “device” may involve one or more actual components, and is not intended to suggest any particular number of cooperating components. FIG. 1 illustrates one computing system 100, which will be referred to in the description of FIG. 1 as computing system-A. Computing system-A 100 may be any computing/communication device capable of presenting web pages or other addressable electronic documents 101 and allowing user interaction therewith. For purposes of this description, reference to a “website,” “web site,” “web page,” “document,” or other analogous term or phrase includes any addressable electronic document(s), page(s), etc. For example, a website may include one or more documents hosted by a network-addressable stand-alone or distributed server system.

While the computing system 100 may be represented by a number of devices as described above, the computing system 100 of FIG. 1 will be described in terms of a computer system such as a personal or desktop computer. The illustrated computing system 100 includes a display or other presentation area 102. Thus, the “presentation” may include, for example, one or more of visual, audio, graphical, tactile, and/or any other form of presenting information to a user. For purposes of the description of FIG. 1, the presentation area 102 is described as involving at least a visual display.

In accordance with one embodiment of the invention, the computer 100 can present media/multimedia via the presentation area 102. This media can be provided by one or more servers 104 coupled to the computer 100 by way of, for example, a network 106. The network represents any one or more network technologies, including global area networks (e.g., the Internet), wired local area networks (e.g., Ethernet), wireless local area networks (e.g., IEEE 802.1x), wireless infrastructure based networks (e.g., GSM/GPRS, PCS, CDMA, etc.). In other words, the network 106 is not limited to any particular network type, protocol or technology, but rather is intended to encompass any manner of facilitating communications via addressable devices. For purposes of the description of FIG. 1, the network 106 is assumed to include at least the Internet.

The computer 100 may use a software module(s) such as a browser to view or otherwise perceive documents, pages, etc., hosted by the server(s) 104. Where the server(s) 104 directly or by proxy provides downloadable, purchasable and/or otherwise retrievable content, visual indicia (e.g., icons, images, graphics, video, etc.) and/or audio (e.g., verbal instructions, sound notifications, etc.) can be presented via the display/presentation area 102. In FIG. 1, visual identifiers or images 108A, 108B, 108C, 108C through 108n are presented to the user via the browser module executing on the computer 100. In the illustrated embodiment, each of the images 108A-108n represents a retrievable content item. For example, a first image represents the content-A identifier 108A, which may correspond to a video clip. As a more particular example, the content-A identifier 108A may represent a music video clip whereby the user of the computer 100 could activate (e.g., click on) the content-A identifier 108A to invoke a multimedia player to present the music video clip. In another embodiment, the content associated with one or more of the identifiers 108A-n may not be usable on the computer 100, but rather usable on the other device 110 as will be described more thoroughly below.

For various reasons, some of which were previously described, browsing sites via another device 10 may not be practical, convenient, possible, desired, etc. For example, many content providers do not cater to mobile devices 112 due to the difficulties or costs in providing such content to these devices. In accordance with one embodiment of the invention, content identifiers such as identifiers 108A-108n can be located via the computer 100, and identified for retrieval or transfer by the other device 110. This “other” device may be any computing system 113, mobile computing/communication device 112, etc. For example, the mobile device 112 may represent a mobile phone 112A, PDA 112B, portable/laptop computer 112C or other mobile communication device 112n. By properly specifying the desired content identifier(s) via the presentation area 102 of computing device-A 100, the content associated with the specified content identifier(s) can thereby be designated for delivery to another device 110, which may be referred to in the description of FIG. 1 as computing system-B 110.

Various manners for specifying the desired content may be used in connection with the invention. One embodiment involves implementing a drag-and-drop graphical user interface (GUI). This embodiment utilizes a drop area 114 to which content identifiers are dragged to designate the associated content for delivery to the associated computing system-B 110. For example, the content-A and content-B identifiers 108A, 108B can be dragged to the drop area 114 using a GUI, whereby the content associated with the identifiers 108A, 108B is thereafter delivered from the server 104 (or other specified network location) to a designated device 110.

In one particular embodiment described more fully below, the drop area 114 may include a representation of the user's other device 110, e.g., a representation of the user's mobile phone 112A, PDA 112B, etc. The representation may identify characteristics, programs, and/or other attributes of the computing system-B 110 that are currently associated with that actual, physical device 110. For example, where the computing system-B 110 is a mobile phone, the drop area may present a representation (not shown) of the user's actual mobile phone, such as a representation of the make and model of the user's phone. The representation of the user's device may also show any one or more of the user's current phone settings, available software programs, stored or accessible content, etc. In other words, the representation of the mobile phone at the designated area 114 can present a “virtual” device that corresponds to the state of the user's actual device 110. Alternatively, the representation of the user's device may itself serve as the drop area 114; i.e., rather than the representation of the user's device being included within the drop area 114, the representation of the user's device may itself constitute the drop area 114. In these manners, actions (e.g., dragging and dropping content) taken relative to the virtual device at the designated area 114 represents the actual actions that will be taken relative to the actual device 110.

The server(s) 104 that hosts the website (or analogous addressable pages/documents) can therefore be equipped with the appropriate hardware, firmware and/or software to perform these functions. The exemplary server(s) 104 includes a device association module 116 that enables the web page(s) presented on the computer's 100 display 102 to include this function where content is made available to the user's other device 110 through actions taken via the computer 100 browser or similar program. For example, the device association module 116 may be implemented via a processing device/system at the server(s) 104 that executes firmware and/or software to present the drop area 114 (and in some embodiments a representation of the user's mobile device 112 or other computing system-B 110), and to facilitate user interface actions at the browser of the computing system-A 100 to affect actual actions at the computing system-B 110. As a more particular example, the device association module 116 can facilitate registration of the user's mobile phone 112A and consequent association with the particular website. When the user accesses that website via the computer 100, the device association module 116 knows to present a representation of the particular user's mobile device 112 at the drop area 114. Synchronization actions can occur to inform the server 104 of the current state of the mobile device 112, to allow a more accurate representation to be presented at the computer 100. The device association module 116 can further recognize which content identifier(s) has been dragged or otherwise associated with the UI region of interest 114, and in turn initiate a transfer of the associated content to the actual mobile device 112. In this manner, content can be delivered to a mobile device without the need to create a special website for the mobile content, or without the need for the content transaction to be managed at the computing system-B 110 itself, which may have more limited UI capabilities than the computing system-A 100.

The device association module 116 can be implemented as, for example, an application programming interface (API). In one embodiment, the API is implemented using HTML code where the website is an Internet site where HTML code is the predominant markup language used on the Internet. In one embodiment, this code enables a plug-in to be implemented as the drop area 114 in the website that shows the UI and content of the user's mobile device 112 (or other device 110). In such an embodiment, the user sees a one-to-one representation of his/her mobile device 112, and it is possible to drag and drop the content items to the frame 114 for ultimate delivery to the device 112. The item can be displayed in the phone UI of the frame 114 in the same manner that it will be presented in the actual mobile device 112.

As indicated above, various manners for specifying the desired content may be used in connection with the invention. The embodiment described above involves implementing a drag-and-drop GUI. Technologies other than drag-and-drop may similarly be used, as drag-and-drop is only one representative manner. For example, the user can enter some text in the text entry area 118 that corresponds to particular content (e.g., “video-xyz”) or address to the content such as a Uniform Resource Identifier (URI).

Another example is to activate (e.g., click on, highlight, etc.) an item on the website that indicates that the next selected item(s) of content are those to be physically transferred to the computing system-B 110 as depicted by the content list module 120. For instance, the user can select a create list 122 function that collects the next one or more selected content identifiers into a list 124. The content associated with those selected items may be immediately transferred to the computing system-B 110, or may be collected until the user activates a send function 126. In one embodiment, selection of the send function 126 removes the web page/browser from the current mode where selection of a content identifier affects the computing system-B 110, and returns the web page/browser to a mode where selection of a content identifier performs its normal function on the computer 100. Thus, a particular example involves the user selecting a create list button 122 on the computer's 100 GUI, selecting one or more content identifiers such as content-C and content-D identifiers 108C, 108D which may optionally be presented at the selected content list 124, and transmitting the listed content or initiating the transfer of the listed content to the device 110 upon selection of the send button 126. As can be seen, the embodiments shown in FIG. 1 for specifying the desired content are illustrated for purposes of facilitating an understanding of aspects of the invention by way of example, and the invention is not limited to the specific examples shown in FIG. 1.

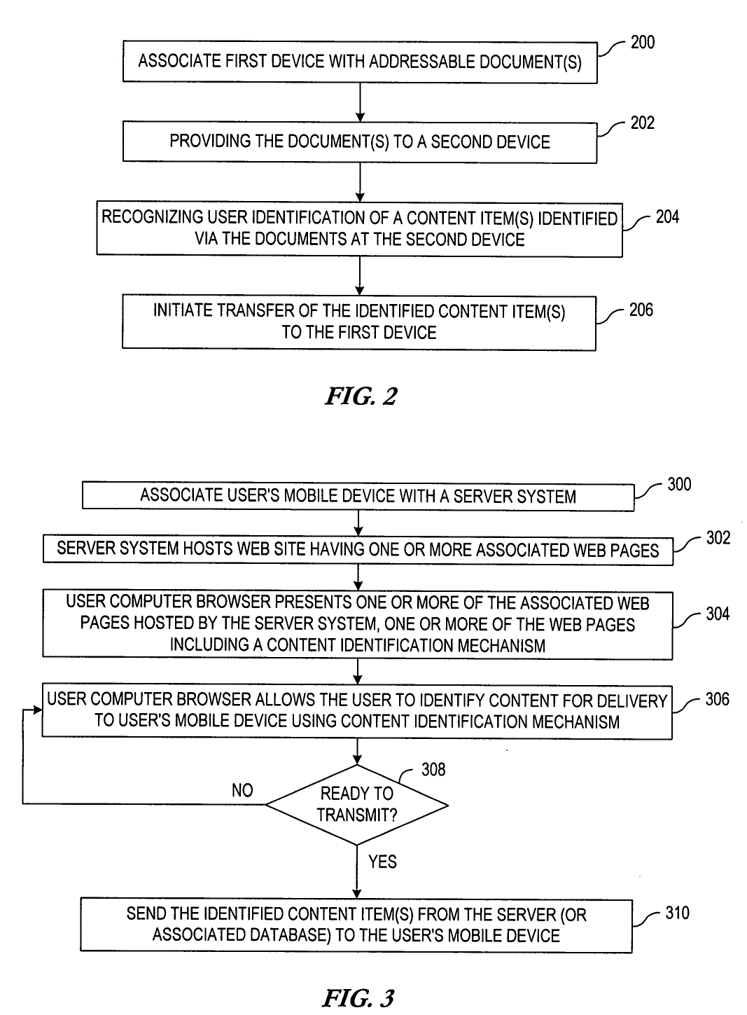

FIG. 2 is a flow diagram illustrating one exemplary manner in which content can be identified for delivery to a targeted device. A first device is associated 200 with an addressable document(s). The first device may be any device such as the device 110 of FIG. 1. It should also be noted that by indicating a “first device,” this does not suggest that there be only one such device—rather, one or more of the user's devices may be associated with the addressable documents. Website documents or pages represent one form of addressable documents. For example, a mobile phone may be associated with a web page such that the web page has some association with the mobile phone. In one embodiment, this association is website code that, when the user has registered his/her mobile device to the web page(s) or website, obtains information regarding the user's mobile device. Thus, in one embodiment, a server associates the mobile device or other device with an addressable website by recognizing information as being that of the user and/or the user's mobile device.

The website pages or documents (hereinafter collectively referred to as page/s) are provided 202 such that they can be presented by devices having a browser or other analogous program allowing such pages to be viewed/consumed. For example, the documents may be provided via a network(s), including networks such as a global area networks (e.g., Internet), local area networks (LANs), and/or other networks. The documents may be “pushed” to a device, or may be “pulled” from the server to a device such as is the case when a browser at the second device enters the address of the website and is directed to the appropriate page(s) at the website server. The invention may involve any manner of providing 202 the document to the second device.

The second device may be a computer or other communication device, such as the computer 100 of FIG. 1. For example, the second device may be a computer also under the direct or indirect control of the user of the first device. More particularly, a person may have a mobile phone, and a desktop computer, where the mobile phone corresponds to the first device and the desktop computer corresponds to the second device. In this example, the user will access the website via the desktop computer, where it gains access to the documents that have been associated with the user's mobile phone (e.g., by prior user registration to the website).

The user can identify content items, via the document(s) presented on the user's desktop computer or other second device, for ultimate delivery to the user's mobile phone or other first device. The user can identify such content items in numerous manners, as described herein. The server recognizes 204 the user's selection of a content item(s) via the document presented on the user's second device. For example, the user's browser may allow the user to identify the appropriate content item(s), which is known to the server hosting the provided document. Upon recognition 204 of the user's selection, the server can initiate 206 a transfer of the identified content to the mobile phone or other first device. In the case of multiple ones of the “first device,” the identified content will be delivered to each of such devices. For example, the user may specify a mobile phone and a PDA as the ultimate receiving devices, and selection of the identified content via the second system can cause the identified content to be delivered to both the user's mobile phone and PDA.

FIG. 3 is a flow diagram illustrating another embodiment of a method for providing content to a content-consuming device. In this representative embodiment, the user's mobile device is associated 300 with a server system. The server system hosts 302 a website having one or more associated web pages. A user computer browser operated on a second device presents 304 the associated web page(s) hosted by the server system, where the web page(s) include a content identification mechanism. For example, in one embodiment, the content identification mechanism is a location on the web page in which content items dragged thereto are thereby selected for subsequent delivery to the user's mobile device. More particularly, as shown at block 306, the user computer browser allows the user to identify content for delivery to the user's mobile device using the content identification mechanism. For example, the user may drag desired content items (e.g., icons or other indicia representing the actual desired content items) to the designated location.

At some time, the server will send 310 the identified content item(s) from the server, or from a source requested by the server, to the user's mobile device. This can be initiated immediately upon the user's identification of the desired content. In another embodiment, desired content can be accumulated via the web page, and the transfer to the mobile device may be initiated later. For example, the user can select a “send” button or otherwise identify via the web page that the user is ready to have the content transmitted. In another embodiment, the transfer may be initiated by a triggering event, such as when the user closes the browser program, points the browser to a different website, a certain time of day, etc. The decision block 308 depicts this flexibility in when the content is actually transferred to the mobile phone or other first device. Thus, if the content is not ready to be transmitted as determined at decision block 308, the user may, among other things, wait until the time or other event occurs that will initiate the transfer 310 of the content, and/or may continue to identify 306 further content. If the content is ready to be transmitted, then the transfer 310 of the identified content is initiated.

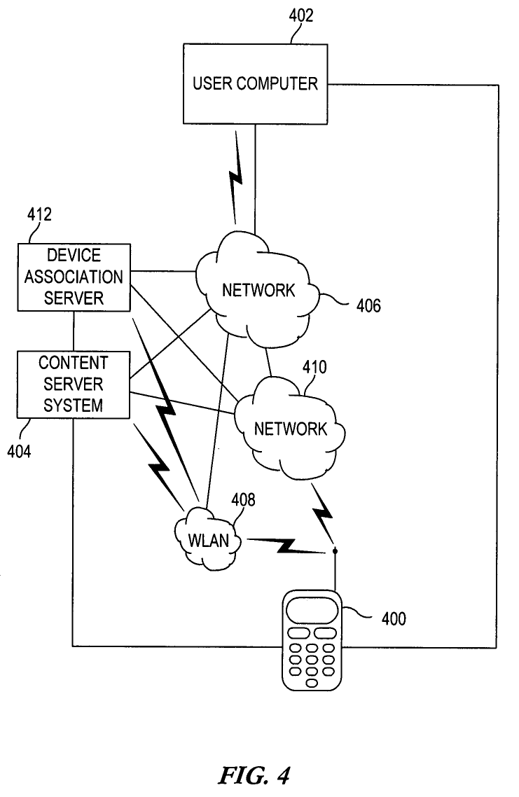

The technical architecture ensures that the items are properly delivered to the mobile device (or other first device). In one embodiment, the server may know the appropriate delivery mechanism based on knowledge obtained when the user registered with the website. In another embodiment, the user can designate a delivery mechanism at the time of identifying the desired content. In another embodiment, the server can detect the manner in which the user's first device is available for communication (e.g.; USB plug-and-play). FIG. 4 illustrates some representative delivery mechanisms that may be used in connection with the present invention.

FIG. 4 shows the user's first and second devices, namely the mobile phone 400 (first device) and the user computer 402 (second device). The server system 404 that provides content, such as a web server, may be a stand-alone or distributed server system. The user computer 402 can access the web pages of the content server system 404 via a network 406 such as the Internet or other large network, local area network (LAN), etc.

The device, to which content is ultimately to be downloaded to, is shown in FIG. 4 as the mobile phone 400. The mobile phone 400 can register to the website of the content server system 404, to enable the association between the phone 400 and the web pages. The mobile phone 400 can communicate with the content server system 404 in any known manner, such as via a WLAN 408 that is coupled to the content server system 404 directly or via a network 406. The mobile phone 400 can also communicate with the server system 404 via a mobile network(s) 410, which may directly or via a network 406 communicate with the content server system 404. The mobile network 410 may include, for example, a GMS/GPRS system, wideband code-division multiple access (WCDMA) system, digital video broadcasting-handheld (DVB-H) system, or other data network.

The device association server 412 represents the server(s) that, as described more fully below, provides information to the content server system 404 such as a unique key code and the API or other code to be inserted into the web page(s). When the web page is provided to the user computer 402, some information such as the phone-related view, the phone's content, and the like may be retrieved from the device association server 412. In one embodiment, content identified via the user computer 402 for transfer to the mobile device 400 is transferred from the content server system 404 to the device association server 412. The device association server 412 can then store the content, and ultimately synchronize with the mobile device 400 to transfer the requested content to the mobile device 400.

Other embodiments do not utilize a synchronization function, but rather have the content delivered from the content server system 404 directly, or via the device association server 412, to the device 400. Depending on the method selected for delivery to the device 400, the appropriate technology may be used, such as WLAN, GPRS, WCDMA, etc. Other direct connection methods may also be used, such as universal serial bus (USB) technology, Ethernet, etc. The user may have preferences as to the preferred delivery mechanism, and any desired delivery technology may be used in connection with the present invention.

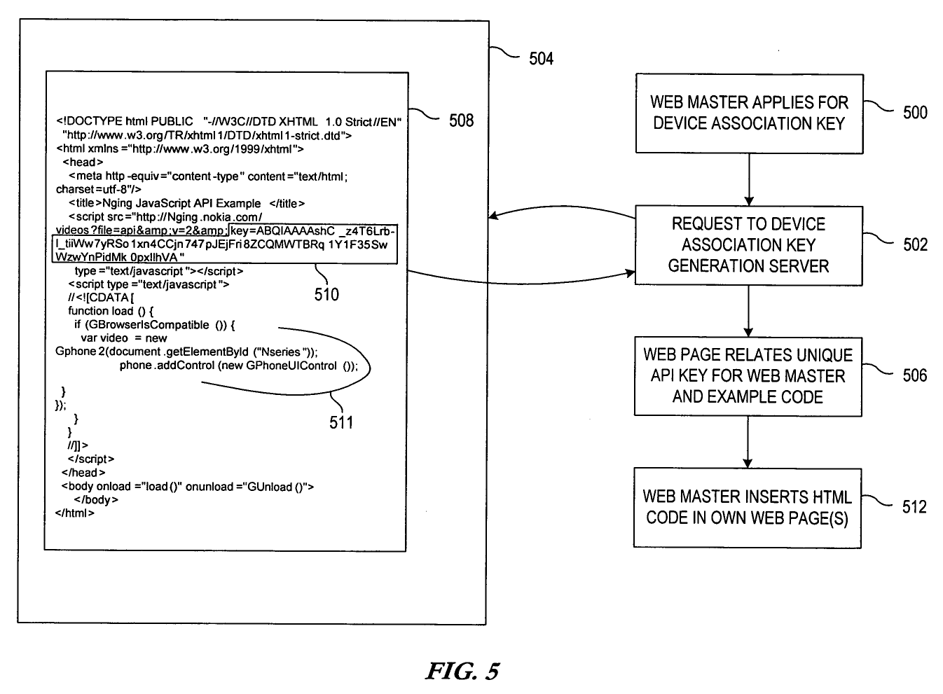

The content identification and delivery functionality of the present invention may be separated into two parts for purposes of facilitating an understanding of aspects of the invention. First considered is the generation of web pages that include the device association functionality described herein. Second, a representative manner in which a user can access these generated web pages and identify content for delivery to a specified device is described. FIG. 5 illustrates a representative flow diagram and code segment that, in one embodiment, can be used for the generation of web pages that include a device association functionality in accordance with the invention. As will be described in the exemplary embodiment of FIG. 5, the invention enables any website to add a code segment, such as HTML code, to the website. This added code is generally referred to herein as the device association code or API. This code enables the website to include a plug-in, frame or other object that presents the user interface and content of the device to which selected media/content is ultimately to be delivered (e.g., mobile phone).

More particularly, FIG. 5 illustrates a flow diagram, where the web master applies for 500 a “key” for the device association code. In one embodiment this key is a unique code that associates the web page with the correct mobile phone (or other device) UI. As shown at block 502, the web master makes a request to the server 504 that generates the device association code and unique key for that web page session. The device association server 412 of FIG. 4 or other designated server may represent the server 504. The key and the device association code are returned to the web master.

The web page relates the unique key and the device association code (e.g., HTML code), as shown at block 506. An example of the additional device association code and embedded unique key is shown at the device association server 504 as the code 508. As shown in the figure, a key is embedded in the code segment 508, such as the example key 510. This key 510 represents a web site-specific identifier that is unique to the respective web site, which allows each of the different web sites to be identified to the device association server 504. Additionally, some code 511 may be included to, when executed, fetch the mobile device-related view, i.e., the representation of the mobile device. Such a command may be provided by way of, for example, JAVA or other similar programming methodology. When the code to fetch the mobile device-related view is executed, it can fetch the correct device representation as the user will be registered to the device association server 504 and/or the web site. The user can enter the model or other identifier of the device, or this information can be obtained in other manners such as via an International Mobile Equipment Identity (IMEI) or other identifier.

In this manner, the code segment 508 corresponds to the particular web site and particular mobile phone (or other device) that the requested content will ultimately be directed to, and corresponds to the particular UI image (if any) of the particular mobile phone that will be presented via the web page(s). Thus, by way of this code 508, an association between the relevant web site page(s) and the mobile device can be established, and thus an association between the particular device and the drop area (e.g., drop area 114 of FIG. 1) or other UI mechanism whereby content is identified for delivery/use by that particular device.

A server can obtain the code segment 508 from a device association server, such as the device association server 412 of FIG. 4. As previously described, the device association server provides information to the content server system (e.g., website server) such as the unique key 510 with the API or other code 508 to be inserted into the web page(s). When the content server has retrieved this information, the code 508 can be embedded into the web page(s) of the website as shown at block 512.

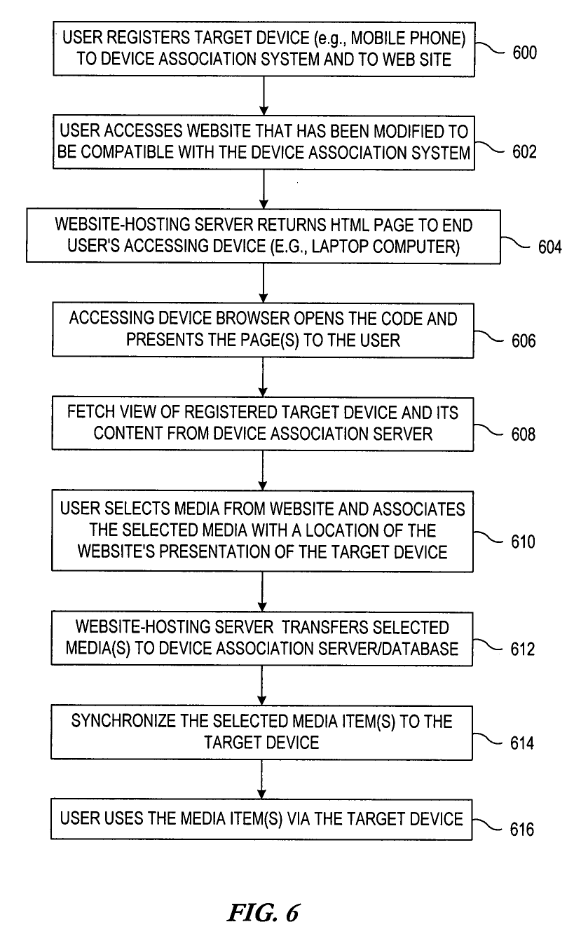

FIG. 6 is a flow diagram illustrating one embodiment of a manner of using the web pages/documents that incorporate the device-associated user interface for identifying deliverable content in accordance with the present invention. For this example, the target device to which content is to be delivered is assumed to be a mobile device, and it is assumed that the user has registered his/her mobile device to the device association system server(s) as well as registering to the web site providing the content. This is depicted in FIG. 6 at block 600, where the user registers the target device(s) to the device association system server and to the web site that will be accessed by the user to identify content for the mobile phone. More on exemplary embodiments for registering devices is described in greater detail below. The target device may be a mobile phone, PDA, other computing system, or other system such as the computing system-B 110 described in connection with FIG. 1.

The user accesses 602 the website or other network-accessible document(s) that has been modified to be compatible with the device association system of the present invention. In other words, the web page(s) includes the embedded device association code, such as embedded HTML code. The server that hosts the web pages returns 604 a page(s) to the end user's accessing device, which may correspond to the computing system-A 100 described in connection with FIG. 1. This accessing device can be any device such as, for example, a laptop computer, desktop computer, workstation, mobile device, etc. In one embodiment, the accessing device is a laptop or desktop computer where it may be easier for the user to browse and identify content to be delivered to the target device. In one embodiment, the page(s) returned includes one or more HTML documents provided to the user's accessing device, such as via a browser program operating on the user's accessing device. The browser or other program opens 606 the HTML or other code associated with that page(s), and presents the page(s) to the user such as by displaying the page via a display.

The device association code that is, for example, embedded into the web page(s) of the content provider's website includes one or more commands to fetch 608 the related representation and/or state of the target device. In one embodiment the fetch command(s) is a JAVA or other similar platform-independent command(s) that the accessing device's browser can then fetch from the device association server, which may or may not be part of the content server. In one embodiment, the device association server(s) is a separately addressable stand-alone or distributed server system from which the target device representations and/or target device states can be retrieved. By way of this fetch command(s) or other manner of initiating the retrieval of the target device representations and/or target device states, the device association server in one embodiment may send at least the representation or “view” of the target device to the browser of the accessing device. In another embodiment, the “state” of the target device is also sent, such as characteristics, programs, and/or other attributes of the target device. Alternatively, the representation of the target device and/or the representation of its contents may be transferred from the device association server to a content server system which in turn may transfer the information to the browser of the accessing device.

The user can select 610 media, multimedia, or other data generally referred to herein as content, from the content provider's website that has been modified in accordance with the present invention. For example, the user can select a media item such as a video clip to be delivered to the target device. In accordance with one embodiment of the invention, this is accomplished by associating the selected media with a location of the website's presentation of the target device. While other embodiments are also available (see, e.g., items 118, 120 of FIG. 1), one embodiment involves such an association of the selected media with a location of the web page's presentation of the target device. For example, this association can be effected by “dragging” the media item via a GUI to a location, such as a drop area, on the modified web page where the representation of the user's target device is presented.

Creating this association between a media item(s) and this web page location causes the corresponding media item (e.g., a video clip) to be transferred from the website-hosting server or other content provider's server. The content may be directly transferred from the website-hosting/content provider's server to the target device. In one embodiment, which is illustrated in FIG. 6, the content is transferred 612 from the website-hosting/content provider's server to the device association system/server for later synchronization with the target device. This embodiment involves storing the content in a device association system database, which serves as personal storage for the user. In one embodiment, this personal storage for each user at the device association system database operates as a personal video recorder (PVR).

The PVR or other storage functionality at the device association system can then synchronize 614 the media item(s) to the target device using any synchronization criteria. For example, the synchronization can be performed via any Internet Protocol (IP) connectivity such as, for example, over WLAN, DVB-H, GPRS, WCDMA, or otherwise depending on the implementation. In one embodiment, the actual media item is then presented via the target device representation on the website presented on the accessing device. In other words, when the media item is actually synchronized with the target device, the “state” of the target device changes, and this is then updated on the representation of the target device on the web page presented on the accessing device. When the media item(s) have been ultimately delivered to the target device such as by way of the synchronization, the user can then use 616 the media item(s) on the target device.

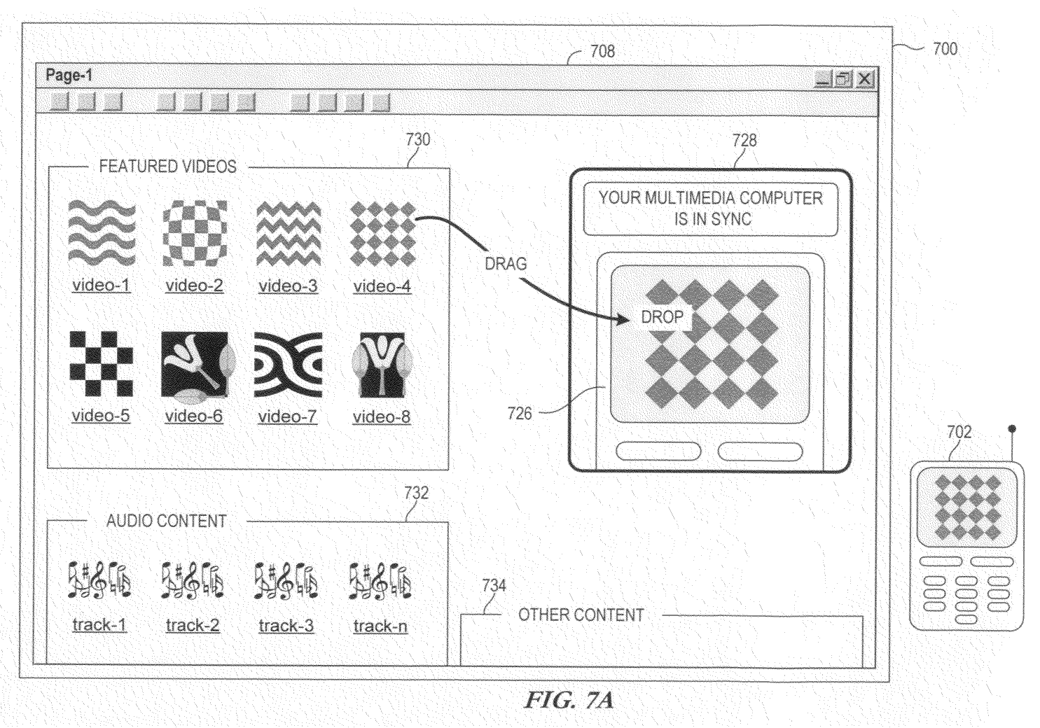

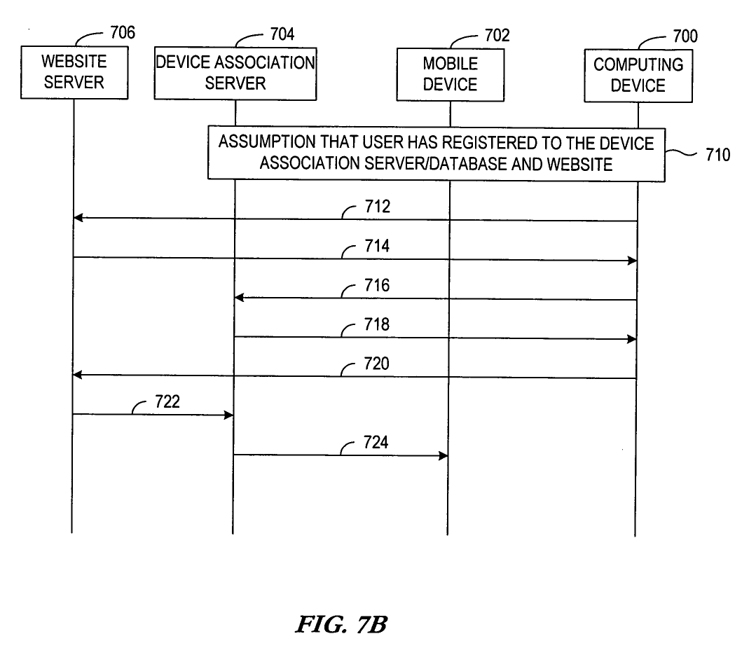

A particular use case is shown in FIGS. 7A and 7B. FIG. 7A illustrates an exemplary web page 708 that can be presented via the user's accessing system 700. The user's accessing system 700 is assumed to be a laptop computer for purposes of this example. FIG. 7B illustrates a message flow diagram representing a user's involvement with the web page 708 and ultimate ability to obtain media on another device, shown as a mobile phone 702 in the present example.

The example of FIG. 7A/7B assumes that the user has registered his/her mobile device 702 to the device association system, and has registered to the web page 708 as well as shown at block 710 of FIG. 7A. The user accesses the web page 708 via the computing device 700 by opening 712 the web page 708 whereby the content provider web site server 706 returns 714 the web page 708. The browser or other agent on the computing device 700 requests 716 the phone related view and/or state information from the device association server(s) 704, which returns 718 this information to the computing device 700.

The mobile phone representation 726 is depicted at a location 728 on the web page 708, as shown in FIG. 7B. The user can identify content on the web page 708 for ultimately delivery to the mobile phone 702, as shown by interaction line 720 of FIG. 7A. One or more areas 730, 732, 734 of FIG. 7B can be provided via the web page(s) 708 that enable the user to select one or more media items using the UI of the computer 700. For example, one such area 730 includes one or more identifiers labeled “video-1,” “video-2,” and so forth, where each of these identifiers corresponds to a video segment. The user may want to browse for and select one or more video clips to view on his/her mobile phone 702. The web page 708 has been modified in accordance with the invention, where a location 728 is provided where one or more of the items can be dragged to the location 728 to select it for delivery to the mobile phone 702. For example, the user can drag the identifier “video-4” from the area 730 to the location 728. As previously described, the location 728 may include a representation of the user's actual mobile phone 702, as is depicted by the mobile phone representation 726. When the user drags the video-4 identifier to the location 728, the process is initiated to ultimately deliver the video clip associated with the “video-4” identifier to the mobile phone 702. In the embodiment of FIG. 7A, the identified content is transmitted 722 from the web site server 706 to the device association system/server 704.

The device association server 704 can then deliver 724 the selected “video-4” media item to the mobile device 702. In one embodiment, the device association server 704 synchronizes any content (stored on behalf of the mobile device 702) with the mobile device 702 in order to provide 724 the content to the mobile device 702. In one embodiment, the identifier and/or video clip may be presented as part of the mobile phone representation 726. In one embodiment, the identifier and/or video clip is shown on the mobile phone representation 726 when it has been dragged to that location 728. In another embodiment, the identifier and/or video clip is shown on the mobile phone representation 726 when the actual video clip has been synchronized or otherwise delivered 724 to the actual mobile phone 702.

As can be seen, this solution enables a content provider or other website to scale up content sales, as browsing and designating content for another device may be more convenient. This also allows users to obtain content more easily for mobile devices or other UI-limited devices where it is easier to browse and/or designate content via another system such as a desktop/laptop computer.

As previously indicated, the mobile device or other target device needs to register with the device association server. By registering the mobile device to the device association system/server, the mobile device can be known to the device association server. In this manner, when the registered mobile device accesses a web page that includes the embedded device association code of the present invention, the mobile device representation can be presented, and content can be identified for delivery to the mobile device by way of the web site. More particularly, registration to the device association server can associate a “key” with the registering mobile device, where the key was previously described to correspond to the particular mobile phone that the requested content will ultimately be directed to, and corresponds to the particular UI image (if any) of the particular mobile phone that will be presented via the web page(s).

Registration can include, for example, particular user profile information such as name, address, e-mail address, etc. It also includes information relating to the user's mobile device. For example, the user's make/model of mobile phone can be automatically determined, or manually entered through the registration process. If the device association server knows these particulars of the user's mobile device, then the appropriate representation can be displayed via the web page, device-compliant delivery protocols can be determined, etc.

Authentication of a mobile terminal to an Internet service or other network service may involve an initial registration to the internet/web service, as well as post-registration authentication of a registered user to the internet/web service (hereinafter referred to as network service). Currently, there are a large number of network services, where registering/authenticating typically involves using a username and password pair. The user must, therefore, maintain numerous username/password pairs. This can be difficult to manage for the mobile user from various perspectives, including the need to store or remember the username/password pair, as well as trying to enter this information via the possibly limited UI of a mobile device. There is also other concerns, such as the possibility of the username/password pair becoming lost or otherwise getting into the wrong hands. Thus, username/password solutions are not always secure, and better ways of authenticating mobile users are needed. One embodiment of the invention addresses these problems, and provides a manner of registering and authenticating a computing/communication system, such as a mobile phone or other mobile device, with a website(s) hosted by a server(s). While this is described in terms of registering/authenticating to network services such as the device association server and/or content server in accordance with the invention, the described registration/authentication concept is equally applicable to registration and/or authentication to any other web sites/servers.

As is described in greater detail below, the mobile device's unique International Mobile Equipment Identity (IMEI), media access control (MAC) address, International Mobile Subscriber Identity (IMSI) or other unique identifier associated with the mobile device is used as a username in one embodiment. Based on that username, a unique network service related password is generated, where in one embodiment this username/password pair is used automatically. As mobile devices and other such terminals may be secured with a personal identification number (PIN), lock code or other security mechanism, there is no need to authenticate the user several times. As indicated above, exemplary data that can be used as the unique username include the IMEI, MAC address, and IMSI, among others. An IMEI is a number that is unique to every mobile phone associated with certain telecommunication systems including Global System for Mobile Communications (GSM) and Universal Mobile Telecommunications System (UMTS). The IMEI may be used by the network to identify a device as a valid device. The MAC address is another unique identifier. Because MAC addresses represent a hardware address that uniquely identifies each node of a network, the MAC address is necessarily unique, at least relative to the network system in which the nodes are operating. An IMSI is also a unique number associated with GSM and UMTS systems. The IMSI (or analogous) is locally stored, typically on the subscriber identity module (SIM). It is sent to the network and may be used to obtain information from the home location register (HLR), visitor location register (VLR), etc.

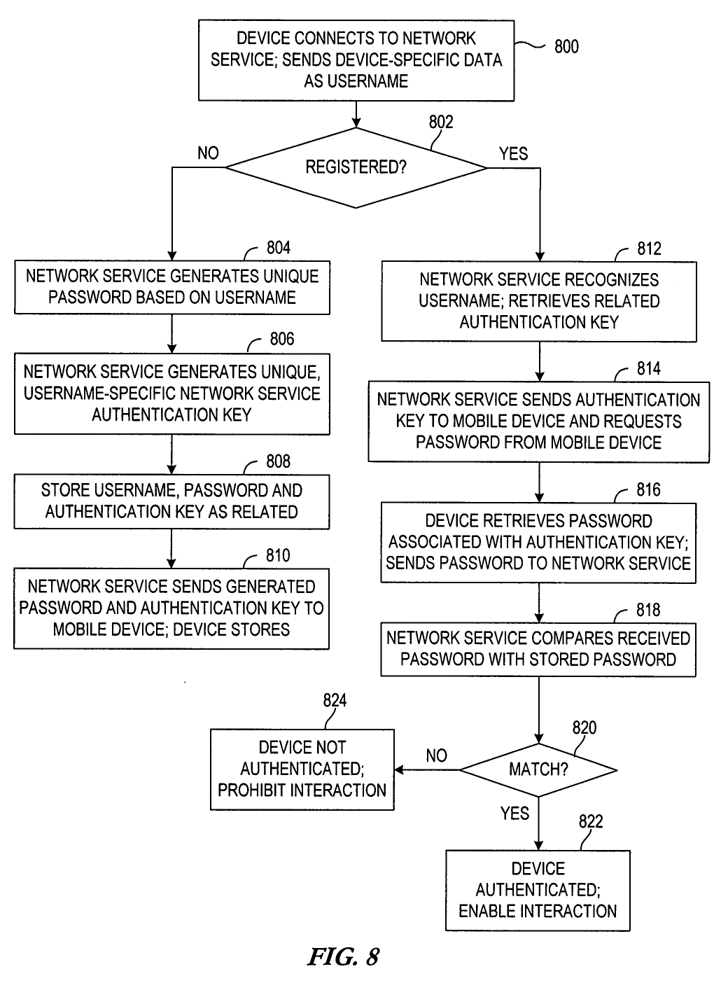

FIG. 8 illustrates one embodiment of a manner for authenticating a device with a network service. The device, such as a mobile phone, PDA, or the like connects 800 to the network service and sends device-specific data for use as the username. The device-specific data may be an IMEI, MAC address, IMSI, or other identifier that can uniquely identify the device. The authentication of the device can be separated into two logical parts, including registration to the network service the first time, and post-registration authentication of a registered user. Thus, if the user has not yet registered the mobile device as determined at decision block 802, then an initial registration process is conducted. In one embodiment, this involves the network service generating 804 a unique password based on the received username, and storing the username/password pair. The network service also generates 806 a unique, username-specific network service authentication key, and stores 808 it with the username and password. The network service may generate the password and/or authentication key, or may request another service to perform one or both of these services. Where the previously described device association server is the network service, the username, password and associated authentication key may be stored in a database associated with the device association service. The network service sends 810 the generated password and network service authentication key back to the mobile terminal where they are stored. The mobile device is thus registered with the network service.

If the user has already registered as determined at decision block 802, then the process becomes the authentication of the registered user. After the mobile device has connected 800 to the network service and sends it's device-specific data as the username, the network service recognizes the mobile device based on the username, and retrieves the previously-stored corresponding authentication key as shown at block 812. The network service sends 814 the authentication key to the mobile device, and requests the mobile device to send back the password that corresponds to that authentication key. The mobile device retrieves 816 this stored password, and provides it to the network service. The network service compares 818 the received password with its stored password for that mobile device. If there is a match, the mobile device is authenticated 822 and further interaction between the device and network service is enabled. Otherwise, the device is not authenticated as shown at block 824, and the device may be prohibited from continuing with obtaining services from the network service.

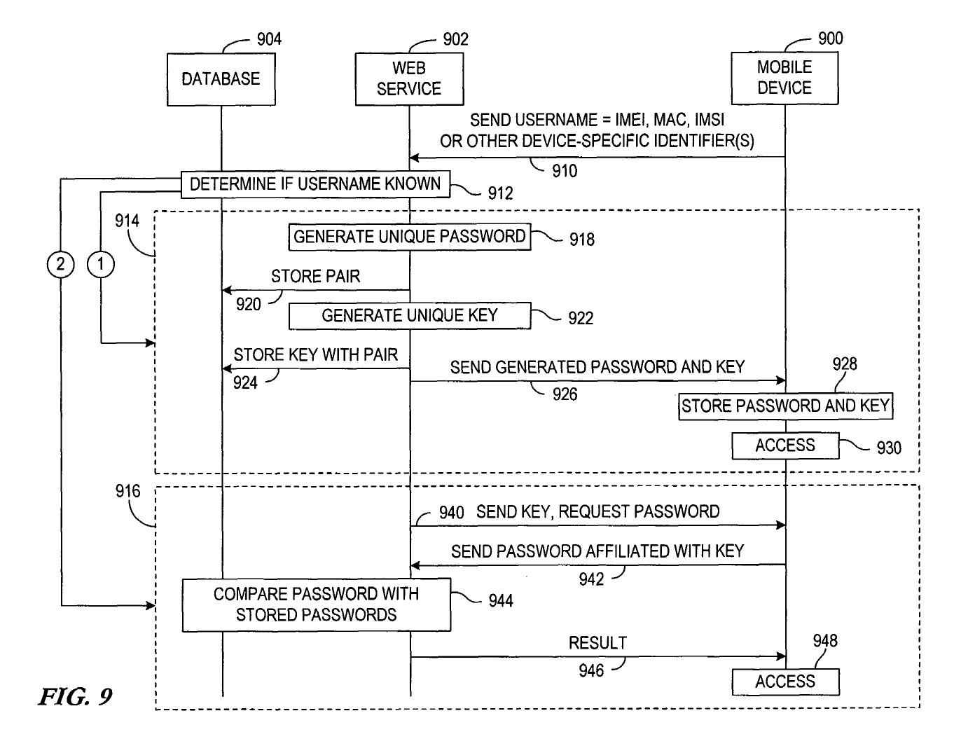

FIG. 9 is a message flow diagram illustrating one embodiment whereby a device may be authenticated with a network service in accordance with the present invention. In the embodiment of FIG. 9, an initial registration phase and a subsequent authentication phase are illustrated. In the illustrated embodiment, it is assumed that the device registering and being authenticated is a mobile device (e.g., mobile phone, PDA, etc.), although the “device” 900 may be any computing/communication system. In one embodiment, the mobile device 900 sends 910 a predetermined unique identifier(s) such as, for example, an IMEI, MAC address, IMSI, etc. The unique identifier is sent 910 to a server(s), identified in FIG. 9 as a web service 902. The unique identifier is used as a username. The web service 902 determines 912 whether the username is known to the web service 902, possibly by checking an associated database 904 if such a database is utilized. If the username is unknown, the mobile device 900 may be registering for the first time, in which case the exemplary message flow operations 914 are performed. If the user has already registered, the exemplary authentication operations 916 are performed.

Assuming the mobile device 900 has not yet registered to the web service 902, the web service 902 generates a unique password using the received 910 unique identifier as the basis. The received username and generated password pair are stored, where one embodiment involves storing the username/password pair in the database 904 as shown by interaction line 920. The web service 902 also generates a unique username-specific web service authentication key as shown at operation 922. This key may be stored 924 along with the username and password. The web service 902 sends 926 the generated password and generated authentication key back to the mobile device 900, where it is stored 928. The mobile device 900 may then access 930 the web service 902.

If the web service 902 determines 912 that the username is known, such as where the mobile device 900 has already registered to the web service 902, the web service sends 940 the authentication key to the mobile device 900. The web service 902 can identify the correct authentication key using the username received from the mobile device 900. By sending 940 the authentication key to the mobile device 900, the web service 902 is asking the mobile device 900 to provide its password to the web service for authentication purposes. The mobile device 900 receives the authentication key, and searches for a previously stored association of a password for that authentication key. The associated password is then sent 942 to the web service 902, which compares the received password with stored passwords, such as stored at the database 904. If the password is found to be associated with the username corresponding to the sent authentication key, the user is allowed to access 948 the web service 902.

Authentication generally involves a process to determine whether a user or device is who or what it says it is. The description above in connection with FIGS. 8 and 9 illustrate exemplary embodiments of a manner of registering the user/device for the purpose of subsequent authentication of the user/device. These techniques can be used for registration/authentication to the content servers and/or device association servers of the present invention, or for registration/authentication to any network service. Other manners for signing on to an internet service may be implemented, such as the additional embodiments described below.

There may be situations where a mobile device must sign on to an internet service, or to multiple internet services concurrently and/or serially. Entering usernames, passwords and the like can be cumbersome via mobile devices due to more limited and smaller user interfaces. If a user must sign on to multiple internet/network services, this can be a lengthy and trying experience, particularly in the case of non-QWERTY user interfaces. For example in one embodiment of the present invention, multiple content items may be selected via one computing system (e.g., desktop computer) for delivery to another system (e.g., mobile device). If content is selected from multiple websites, and the content is ultimately to be delivered to the mobile device, the mobile device may need to sign on to each of the websites from which content is to be retrieved. Similarly, if the user of accessing system (e.g., desktop computer) is browsing to multiple sites, signing on to each of these sites can be time-consuming. Additionally, it can be difficult for the user to maintain the potentially large number of username/password pairs for each of these sites, particularly where the user is mobile. Thus, it would be desirable to have a manner in which a user can log onto a service (networked or otherwise) where entry of a username/password pair would not be necessary.

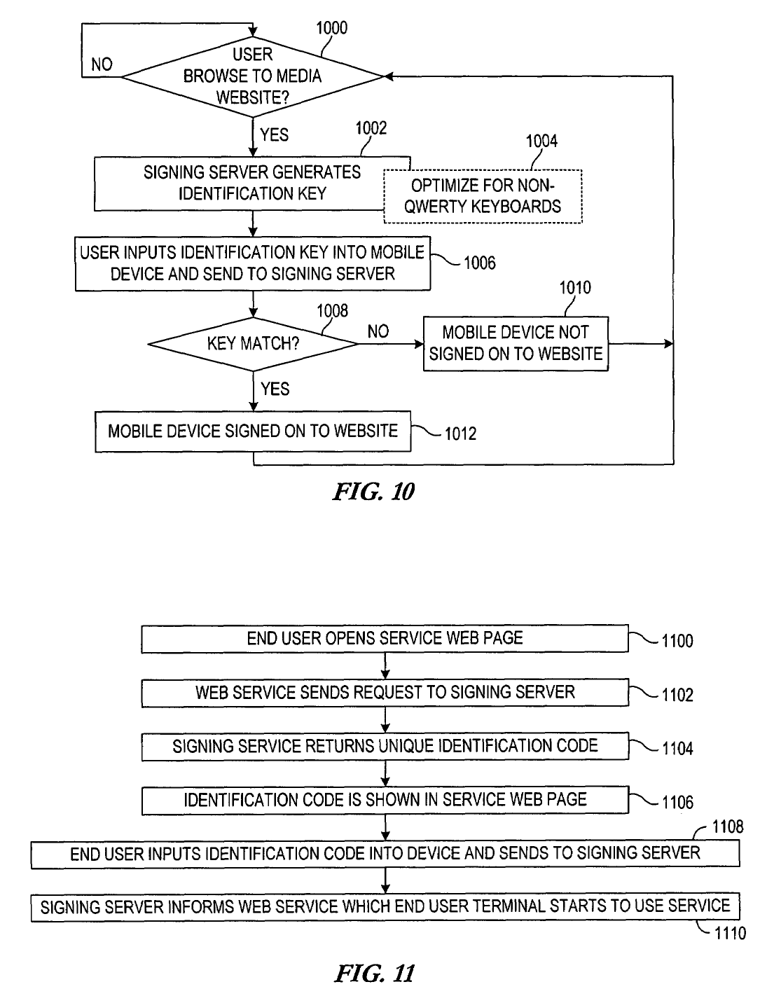

FIG. 10 is a flow diagram illustrating an exemplary manner of logging on to a network or other service without requiring a username/password pair to be entered by the user. One embodiment involves using a unique web page-related identification key. In one embodiment, these identification keys are generated such that they are optimized for mobile device input mechanisms lacking a QWERTY keyboard. In one embodiment an logical or physical intermediary network element (e.g., server) can be used as the signing server for one, some or all of the web service sessions with content servers or other network services. For example, the device association server may include a signing server functionality to facilitate signing onto the network services for the mobile device. In one embodiment, the particular identification key may be optimized for the specific device type or device genre; e.g., if the device is a non-QWERTY input device, the key may be optimized for such user input, as described more fully below.

When the user browses or otherwise gets directed to the media website as determined at decision block 1000, the signing server generates 1002 an identification key. In one embodiment, this is optimized for the type of device that will be signing on. This optimization can include any manner of facilitating or otherwise making easier the user's entry of the information. For example, in the illustrated embodiment, this “optimization” is for non-QWERTY keyboards as shown at block 1004. For example, the resulting key that will be entered via the mobile (or other) device may include letters that correspond to a first button pressed when using a standard mobile phone keypad where an “a” requires pressing the number “2” key once, a “b” requires pressing the number “2” key twice, an “s” requires pressing the “7” key four times, etc. Thus, an “optimized” identification key may be, for example, “djmjtw,” all of which result from pressing the associated number key once. Another example of “optimizing” may be that the resulting key does not mix letters and numbers, so that the user does not have to switch between alpha characters and numeric characters. Another example is to ensure that any letters are either not case sensitive, or if case sensitive to have the key be of the case letter case (e.g., all uppercase or all lowercase). These and/or other examples of optimizing the ultimate entry by the user, which is considered when generating 1002 the identification key.

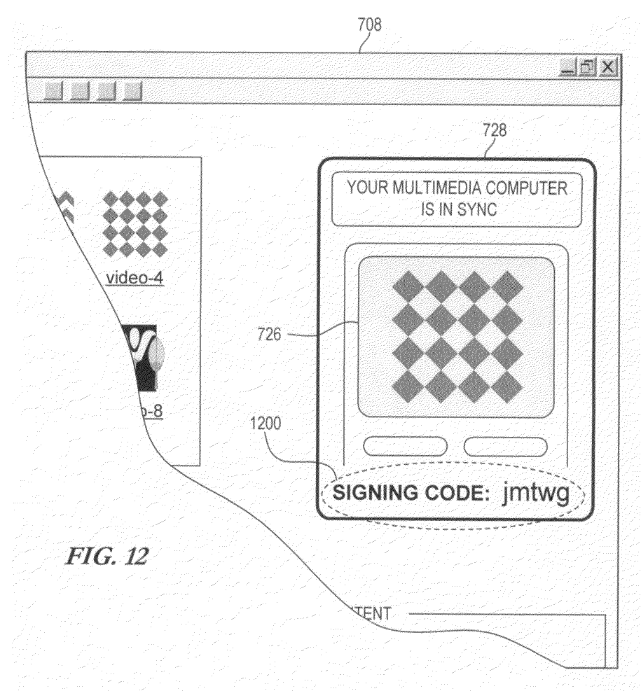

The user is informed of the generated identification key and inputs 1006 the key into the device for transmission to the signing server. In one embodiment, the user is informed of the generated identification key via a web page(s) that is being visited by the user, such as the web page 708 shown in FIG. 7A. In another embodiment, the generated identification key is provided at the location at least loosely corresponding to the location at which the representation of the target device is presented, such as the location 728 of FIG. 7A. An example of this is shown in FIG. 12, which uses like reference numbers to those of FIG. 7A where appropriate. As seen in FIG. 12, the illustrated embodiment presents the signing server-generated identification key to the user at the location 728, although this need not be the case. The identification code, shown in FIG. 12 as the “signing code,” presents the code to the user which in the illustrated embodiment is “jmtwg.”

Returning to FIG. 10, the user inputs the identification key into his/her mobile device and sends it back to the signing server, as shown at block 1006. If the returned identification key does not match the generated key as determined at decision block 1008, the mobile device is not signed onto the website/webpage as shown at block 1010. If there is a match, the mobile device can sign on 1012 to the website/webpage, and the web service and mobile device are thereby signed.

FIG. 11 is a flow diagram illustrating another embodiment of a manner of logging on to a network or other service without requiring a username/password pair to be entered by the user. In this embodiment it is assumed that each web service that is using the signing service in accordance with this aspect of the invention will receive a unique key for each new web service session. It should be recognized that “unique” in this sense does not require complete uniqueness relative to any code, but rather is unique relative to other codes that may be used in the system—i.e., it is unique in that no two (or more) keys will be generated with the same value. The key may be generated locally, or may be requested from elsewhere, such as from a key generator server which may have an key database associated therewith. When an end user opens 1100 such a web service (e.g., accesses the homepage or other relevant page/document hosted by the web service), the web service sends 1102 a request to a signing server for a new key. The signing service returns 1104 a unique identification code, which may be stored in the key database. As previously described, one optional embodiment involves providing such a unique key in an optimized fashion to accommodate the user interface limitations and/or advantages of the user's code entry device (e.g., mobile phone). It should be noted that the term “optimized” and variants thereof as used in this description do not imply that it must be the best possible manner, but rather that at least some manner of improving the ease in which the user can enter the identification code is implemented, such as limiting keystrokes, etc.

The identification code is made known to the user. In one embodiment, this is accomplished by providing a visual indication, audible indication, tactile indication, and/or other presentation to the user via the web server's website/webpage that the user is accessing. In the embodiment of FIG. 11, the manner of presenting the code is to at least visually show 1106 the code to the user via the web page. An example of presenting the code visually was described in connection with FIG. 12. Having knowledge of this identification code, the user can input 1108 the identification code into his/her device for delivery to the signing server. For example, the identification code may be entered using a signing application, pre-configured Internet link or other entry mechanism to allow text, voice commands, GUI entry and/or other input mechanism to specify the identification code. The code may be transmitted via any known manner, including, for example, using any IP connection such as via GPRS or WLAN, short message service (SMS), etc. In any desired fashion, the code is entered into the device and transmitted to the signing server.

Since the key database (or other storage) stores associations of the identification keys and web services, the signing server can inform 1110 the web service which end user device is starting to use the service. With this information, the web service can present in the display the personalized information, such as the mobile device screen with subscribed services, in the end user's desktop computer or other accessing system. If the user desires, the web service can store a cookie(s) in the accessing system, which can then be used for seamless signing in. In one embodiment, if the web service finds a cookie(s) in the system, it will not request a key from the signing server.

As indicated above, an accessing system such as a desktop or laptop computer may be used to browse to or otherwise access web sites/pages for content to be delivered to another device such as a mobile device. It is quite possible that the user will have multiple sessions opened at the same time, and the user may need to sign onto (e.g., login) multiple web services via the accessing system. Each of these different web services typically involves a different username/password pair for the user, thereby requiring the user to enter the username and password into each of the different secured sessions associated with various network services.

One embodiment of the invention involves enabling multiple service sessions to be opened with less login information, with one embodiment involving the use of as few as a single login entry. For example, assume that the user is opening a new web page that has been modified to be compatible with the device association system of the present invention; e.g., the web page(s) includes the embedded device association code/API. There are different scenarios that may apply when the user attempts to open the web page. For example, a first scenario may be that the user may have previously logged into the service, and a second scenario may be that the user has not previously logged into the particular service. In the first scenario where the user has previously logged into the service, the user's browser (or analogous) can offer a cookie of the session to the device association server. A cookie is a data item that can be used to differentiate between users, authenticate users, track and maintain information about users, etc.

In the case where the user has not previously logged into the service that has been modified to be compatible with the device association system of the present invention, there is no cookie associated with that web page(s) in the memory of the computing device. For example, if a user has not accessed such a website using a personal computer as an accessing system, the personal computer will not have a cookie(s) stored for that website. However, the user may or may not have logged into some other web service that has been modified to be compatible with the device association system of the present invention (hereinafter referred to as a “compatible” web site/page/service). If the user has logged into some other compatible web service with that device, one embodiment of the invention involves the data association server searching the cache or other memory of the accessing system for a cookie(s) of a different session with a compatible website. If found, that cookie is used instead, and is delivered to the device association server where it can be authenticated and returned to the accessing system as the proper cookie. After that, the web site/page will work with that device. If the user has not ever logged on to any “compatible” websites, then the normal authentication procedure can be used.

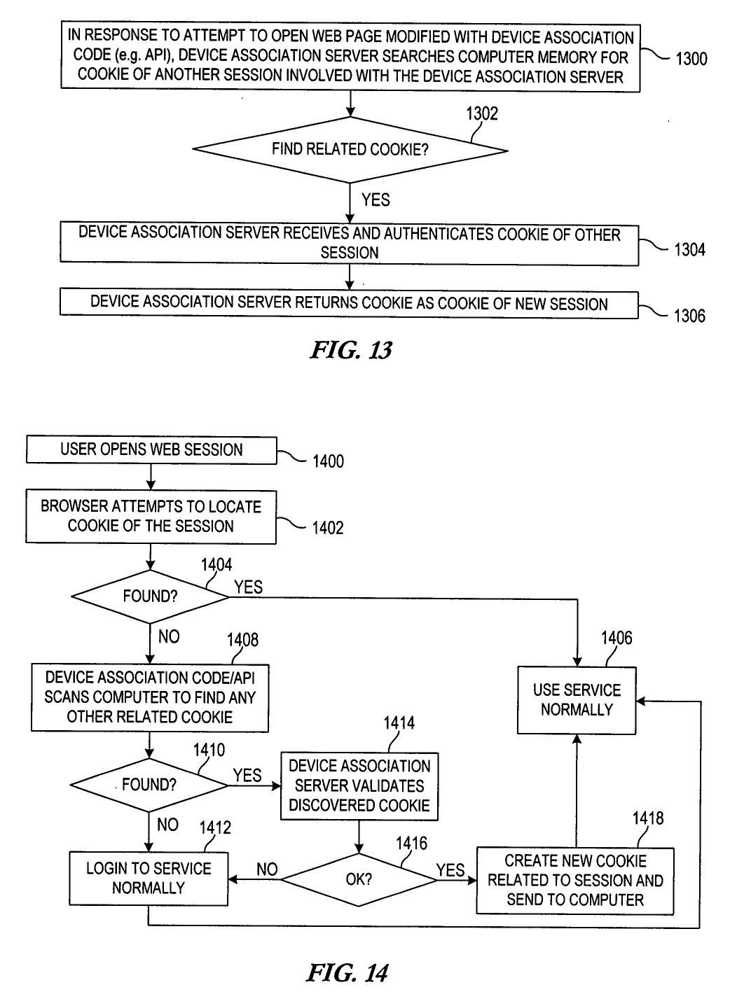

FIGS. 13 and 14 are flow diagrams of exemplary embodiments of such manners of opening multiple service sessions with as few as one login. As shown at block 1300 of FIG. 13, a user may attempt to open a web page that has been modified with the device association code, and in response the device association server may search the computer storage for a cookie of another session involved with the device association server. For example, if a different session with a “compatible” website (i.e., has been modified to include the device association code/API), the server searches for a cookie(s) associated with that session. If the search for such a “related” cookie is found as determined at decision block 1302, the device association server receives and authenticates that cookie of the other session as shown at block 1304. The device association server then returns 1306 the cookie as the cookie of the new session. Thus, a cookie associated with a different compatible website is initially used as the cookie to return to the device association server, which in response returns a new, appropriate cookie for the current session to the computing system that is involved in the login process (e.g., accessing system).

FIG. 14 illustrates another exemplary embodiment, where the user opens 1400 a web session. It is assumed that this web session is with a website/server that has been modified with the device association code as previously described. The local browser attempts to locate 1402 a cookie of the particular session. If found 1404, the service can be used normally without any further login data. If a cookie is not found 1404, the device association code/API scans the computing system to locate any other “related” cookie(s) as shown at block 1408. As previously indicated, for purposes of this explanation, a “related” cookie(s) is a cookie that was stored for another session with a web site that has been modified to be compatible with the device association system of the present invention. If a cookie is not found 1410 for another such session, then the login to the service is conducted normally 141. Otherwise, if a related cookie is found 1410, the device association server validates 1414 the discovered cookie. If validation of that cookie is not successful 1416, then the login to the service is conducted normally 141. If validation is successful 1416, a new cookie related to the new session is created 1418 and sent to the computing system.

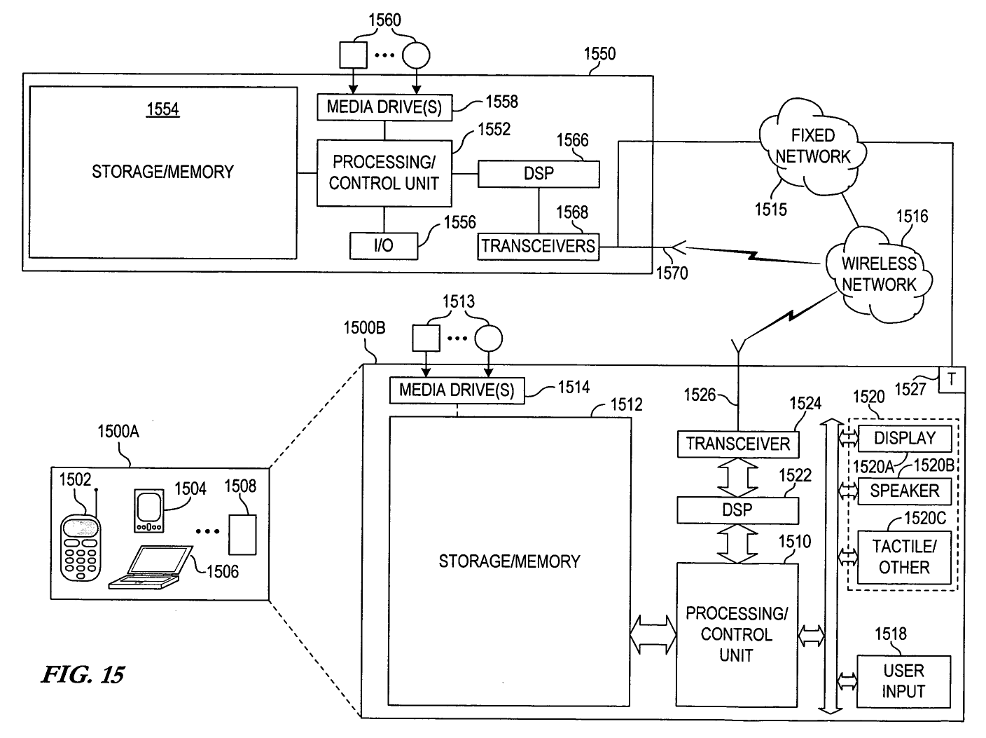

A representative system in which the present invention may be implemented or otherwise utilized is illustrated in FIG. 15. The communication device(s) 1500A represents any communication device capable of performing the device/terminal functions previously described. In the illustrated embodiment, the device 1500A represents a mobile device capable of communicating over-the-air (OTA) with wireless networks and/or capable of communicating via wired networks. By way of example and not of limitation, the device 1500A includes mobile phones (including smart phones) 1502, personal digital assistants 1504, computing devices 1506, and other networked terminals 1508.

The representative terminal 1500A utilizes computing systems to control and manage the conventional device activity as well as the device functionality provided by the present invention. For example, the representative wireless terminal 1500B includes a processing/control unit 1510, such as a microprocessor, controller, reduced instruction set computer (RISC), or other central processing module. The processing unit 1510 need not be a single device, and may include one or more processors. For example, the processing unit may include a master processor and one or more associated slave processors coupled to communicate with the master processor.

The processing unit 1510 controls the basic functions of the terminal 1500B as dictated by programs available in the program storage/memory 1512. The storage/memory 1512 may include an operating system and various program and data modules associated with the present invention. In one embodiment of the invention, the programs are stored in non-volatile electrically-erasable, programmable read-only memory (EEPROM), flash ROM, etc., so that the programs are not lost upon power down of the terminal. The storage 1512 may also include one or more of other types of read-only memory (ROM) and programmable and/or erasable ROM, random access memory (RAM), subscriber interface module (SIM), wireless interface module (WIM), smart card, or other fixed or removable memory device/media. The programs may also be provided via other media 1513, such as disks, CD-ROM, DVD, or the like, which are read by the appropriate interfaces and/or media drive(s) 1514. The relevant software for carrying out terminal operations in accordance with the present invention may also be transmitted to the terminal 1500B via data signals, such as being downloaded electronically via one or more networks, such as the data network 1515 or other data networks, and an intermediate wireless network(s) 1516 in the case where the terminal 1500A/1500B is a wireless device such as a mobile phone.

For performing other standard terminal functions, the processor 1510 is also coupled to user input interface 1518 associated with the terminal 1500B. The user input interface 1518 may include, for example, a keypad, function buttons, joystick, scrolling mechanism (e.g., mouse, trackball), touch pad/screen, or other user entry mechanisms (not shown).

A user interface (UI) 1520 may be provided, which allows the user of the terminal 1500A/B to perceive information visually, audibly, through touch, etc. For example, one or more display devices 1520A may be associated with the terminal 1500B. The display 1520A can display web pages, images, video, text, links and other information. A speaker(s) 1520B may be provided to audibly present instructions or other information. Other user interface (UI) mechanisms can also be provided, such as tactile 1520C or other feedback. The information associated with the present invention may be provided by any type of presentation perceivable by the user.

The exemplary mobile device 1500B of FIG. 15 also includes conventional circuitry for performing wireless transmissions over the wireless network(s) 1516. The DSP 1522 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 1524 includes at least a transmitter and receiver, thereby transmitting outgoing radio signals and receiving incoming radio signals, generally by way of an antenna 1526. Where the device 1500B is a non-mobile or mobile device, it may include a transceiver (T) 1527 to allow other types of wireless, or wired, communication with networks such as the Internet. For example, the device 1500B may communicate via a proximity network (e.g., IEEE 802.11 or other wireless local area network), which is then coupled to a fixed network 1515 such as the Internet. Peer-to-peer networking may also be employed. Further, a wired connection may include, for example, an Ethernet connection to a network such as the Internet. These and other manners of ultimately communicating between the device 1500A/B and the server 1550 may be implemented. In one embodiment, the storage/memory 1512 stores the various client programs and data used in connection with the present invention.

It should be recognized that the modules 1530-1535 may be separate modules operable in connection with the processor 1510, may be single module performing each of these functions, or may include a plurality of such modules performing the various functions. In other words, while the modules are shown as multiple software/firmware modules, these modules may or may not reside in the same software/firmware program. It should also be recognized that one or more of these functions may be performed using hardware. For example, a compare function may be performed by comparing the contents of hardware registers or other memory locations using hardware compare functions. These client and data modules are representative of the types of functional and data modules that may be associated with a terminal in accordance with the invention, and are not intended to represent an exhaustive list. Also, other functions not specifically shown may be implemented by the processor 1510.

FIG. 15 also depicts a representative computing system 1550 operable on the network. One or more of such systems 1550 may be available via a network(s) such as the wireless 1516 and/or fixed network 1515. In one embodiment, the computing system 1550 represents the data association server as previously described, or may represent a laptop or other accessing computing system in accordance with the invention. The system 1550 may be a single system or a distributed system. The illustrated computing system 1550 includes a processing arrangement 1552, which may be coupled to the storage/memory 1554. The processor 1552 carries out a variety of standard computing functions as is known in the art, as dictated by software and/or firmware instructions. The storage/memory 1554 may represent firmware, media storage, and/or memory. The processor 1552 may communicate with other internal and external components through input/output (I/O) circuitry 1556. The computing system 1550 may also include media drives 1558, such as hard and floppy disk drives, CD-ROM drives, DVD drives, and other media 1560 capable of reading and/or storing information. In one embodiment, software for carrying out the operations at the computing system 1550 in accordance with the present invention may be stored and distributed on CD-ROM, diskette, magnetic media, removable memory, or other form of media capable of portably storing information, as represented by media devices 1560. Such software may also be transmitted to the system 1550 via data signals, such as being downloaded electronically via a network such as the data network 1515, Local Area Network (LAN) (not shown), wireless network 1516, and/or any combination thereof. In accordance with one embodiment of the invention, the storage/memory 1554 and/or media devices 1560 store the various programs and data used in connection with the present invention, depending on whether the system 1550 represents the data association server(s) or an accessing system.

The illustrated computing system 1550 also includes DSP circuitry 1566, and at least one transceiver 1568 (which is intended to also refer to discrete transmitter/receiver components). While the server 1550 may communicate with the data network 1515 via wired connections, the server may also/instead be equipped with transceivers 1568 to communicate with wireless networks 1516 whereby an antenna 1570 may be used.

Hardware, firmware, software or a combination thereof may be used to perform the functions and operations in accordance with the invention. Using the foregoing specification, some embodiments of the invention may be implemented as a machine, process, or article of manufacture by using standard programming and/or engineering techniques to produce programming software, firmware, hardware or any combination thereof. Any resulting program(s), having computer-readable program code, may be embodied within one or more computer-usable media such as memory devices or transmitting devices, thereby making a computer program product, computer-readable medium, or other article of manufacture according to the invention. As such, the terms “computer-readable medium,” “computer program product,” or other analogous language are intended to encompass a computer program existing permanently, temporarily, or transitorily on any computer-usable medium such as on any memory device or in any transmitting device.

From the description provided herein, those skilled in the art are readily able to combine software created as described with appropriate general purpose or special purpose computer hardware to create a computing system and/or computing subcomponents embodying the invention, and to create a computing system(s) and/or computing subcomponents for carrying out the method(s) of the invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method comprising:
associating a first device with at least one network-addressable document;
providing the network-addressable document to a second device;
recognizing user identification of at least one content item identified by way of the at least one network-addressable document presented via the second device; and
initiating a transfer of the at least one identified content item to the first device that is associated with the at least one network-addressable document.

2. The method of claim 1, further comprising providing at least one region on the network-addressable document, and wherein recognizing user identification of at least one content item comprises recognizing user correlation of the at least one content item with the at least one region on the addressable document.

3. The method of claim 1, further comprising presenting at least one region via the addressable document and facilitating user correlation of the at least one content item with the at least one region.

4. The method of claim 3, wherein recognizing user identification of the at least one content item comprises recognizing moving an icon identifying the at least one content item to the at least one region via a drag-and-drop graphical user interface.

5. The method of claim 3, further comprising presenting a visual representation of the first device at the presented region of the addressable document.

6. The method of claim 5, further comprising synchronizing at least some information between the first device and the visual representation of the first device.

7. The method of claim 5, further comprising incorporating a state of the first device with the visual representation of the first device.

8. The method of claim 1, wherein associating a first device with at least one network-addressable document comprises modifying the network-addressable document code to include a code segment that associates the first device with the network-addressable document.

9. The method of claim 8, wherein the code segment is implemented using a Hypertext Markup Language (HTML) Application Programming Interface (API).

10. The method of claim 1, wherein associating a first device with at least one network-addressable document comprises providing a site-specific identifier and code segment to a network service providing the network-addressable document, wherein the site-specific identifier associates the network-addressable document with the first device, and the code segment enables a browser application on the second device to present information regarding the first device via the network-addressable document.

11. The method of claim 10, wherein the code segment enables the browser application on the second device to present a representation of the first device via the network-addressable document.

12. The method of claim 10, wherein the code segment enables the browser application on the second device to present the state of the first device via the network-addressable document.

13. The method of claim 1, further comprising facilitating selection, via the second device, of one or more content items presented on the network-addressable document(s) for use by the first device.

14. The method of claim 1, wherein recognizing user identification of at least one content item comprises recognizing at least one of a user voice command of the at least one content item, user entry of text that identifies the at least one content item, or user selection of the at least one content item via a graphical user interface.

15. The method of claim 1, further comprising registering the first device with the network-addressable document, and incorporating code corresponding to the registered first device.

16. The method of claim 1, wherein initiating a transfer of the at least one identified content item to the first device comprises transferring the at least one identified content item from a server hosting the network-addressable document to the first device.

17. The method of claim 1, wherein initiating a transfer of the at least one identified content item to the first device comprises initiating the transfer via a network service hosting the network-addressable document.

18. The method of claim 17, further comprising:
the network service transferring the content item to an intermediary server operating as personal storage for the first device; and
providing the content item to the first device by synchronizing the personal storage at the intermediary server with the first device.

19. The method of claim 18, wherein transferring the content item to an intermediary server operating as personal storage for the first device comprises transferring the content item to a database at the intermediary server serving as a personal video recorder (PVR).

20. The method of claim 1, wherein the network-addressable document comprises at least one Internet web page.

21. The method of claim 1, wherein the first device is a mobile communication device, and the second device is a computing device.

22. A method comprising:
generating a device association key that associates a web page with a communication device;
providing the device association key to a requesting network service hosting the web page;
providing a representation of a communication device to the web page that is identified by the device association key; and
identifying content selected using the representation of the communication device on the web page presented via the computing device, and facilitating a transfer of the selected content to the communication device.

23. The method of claim 22, further comprising providing a supplementary code segment for inclusion into the web page as an Application Programming Interface (API).

24. The method of claim 22, wherein facilitating a transfer of the selected content to the communication device comprises synchronizing data with the communication device.

25. The method of claim 22, wherein facilitating a transfer of the selected content to the communication device comprises notifying the network service hosting the web page to transmit the content to the communication device.

26. The method of claim 22, wherein facilitating a transfer of the selected content to the communication device comprises receiving the content from the network service hosting the web page, and synchronizing the content with the communication device.

27. An apparatus comprising:
a transmitter;
a receiver to receive a request from a network service hosting a web page for a device association key that associates a web page with a communication device; and
a processor configured to generate the device association key, to direct the transmitter to provide the device association key, to provide a representation of the communication device to the web page being accessed by a computing device, and to facilitate a transfer to the communication device of content identified by graphically moving a content identifier to the representation of the communication device.

28. The apparatus as in claim 27, wherein the processor is further configured to facilitate registration of the user's mobile phone and consequent association with the website.

29. The apparatus as in claim 27, wherein the processor is further configured to recognize which one or more content identifiers have been dragged or otherwise associated with the representation of the communication device.

30. A method comprising:
registering a first device with a device association service and a network service;
authenticating the first device with the device association service, and if authenticated, the device association service associating the first device with at least one network-addressable document hosted by the network service;
providing the network-addressable document to a second device;
recognizing user identification of at least one content item identified by way of the at least one network-addressable document presented via the second device; and
authenticating the first device with the network service, and if authenticated, initiating a transfer of the at least one identified content item to the first device.

31. The method of claim 30, wherein authenticating the first device with the network service comprises:
utilizing an identifier already affiliated with the first device as a username;
generating a password and an authentication key based on at least the username; and
upon attempted access to the network service by the first device, exchanging the username, password and authentication key to determine the authenticity of the first device.

32. The method of claim 30, wherein authenticating the first device with the device association service comprises:
utilizing an identifier already affiliated with the first device as a username;
generating a password and an authentication key based on at least the username; and
upon attempted access to the device association service by the first device, exchanging the username, password and authentication key to determine the authenticity of the first device.

33. A method comprising:
associating the first device with at least one network-addressable document hosted by the network service;
facilitating a sign-on procedure to enable the first device to sign on to the network service;
providing the network-addressable document to a second device;
recognizing user identification of at least one content item identified by way of the at least one network-addressable document presented via the second device; and
if the sign-on procedure is successful, initiating a transfer of the at least one identified content item to the first device.

34. The method of claim 33, wherein facilitating a sign-on procedure to enable the first device to sign on to the network service comprises:
receiving a notification of a user requesting access to the network service;
generating an identification key for a session of the network service that provides the network-addressable document, and providing the identification key to the network service session for presentation to the user requesting access to the network service;
receiving a user-entered identification key via the network service session; and
comparing the generated identification key to the user-entered identification key to effect the sign-on procedure.

35. The method of claim 33, further comprising signing the user onto the network service session if the generated identification key corresponds to the user-entered identification key.

36. An apparatus comprising:
a processor configured to register the apparatus;
a receiver configured to receive media identified via operations taken relative to an external representation of the registered apparatus; and
a user interface configured to present the externally identified media.

37. The apparatus of claim 36, wherein the receiver is configured to receive the media by way of a synchronization event with storage associated with a device association system to which the apparatus has registered.

38. The apparatus of claim 36, wherein the receiver is configured to receive the media directly from a content server.
